(19) United States
(12) Patent Application Publication
(10) Pub. No.: US 2026/0023643 A1
(43) Pub. Date: Jan. 22, 2026

(54) PREDICTIVE SELF-HEALING SYSTEM FOR COMPUTER ARCHITECTURES

(71) Applicant: Capital One Services, LLC, McLean, VA (US)

(72) Inventors: Vamshi Krishna Ciramdas, Frisco, TX (US); Satish Chikkaveerappa, Mckinney, TX (US); Kevin Gaynor, Priceton, TX (US); Matthew Attilio Russo, Mount Sanai, NY (US)

(21) Appl. No.: 18/779,789

(22) Filed: Jul. 22, 2024

(51) Int. Cl. G06F 11/07; G06F 16/901

(52) U.S. Cl. CPC G06F 11/0793; G06F 11/0709; G06F 11/079; G06F 16/9024

(57) ABSTRACT

Aspects discussed herein may relate to methods and techniques for using a multi-step approach to automatically analyze the computer architecture to determine the possible points of failure. A first stage may process, such as by using machine learning, one or more architecture diagrams the system architecture using hardware and/or software. The first stage may create a data graph that summarizes the network architecture and its relationships. A second stage may take the data graph and process it to determine likely points of failure and/or areas where redundancy may be needed. The system may then determine remedial steps to take in the case of failure

### FIELD AND BACKGROUND OF THE INVENTION

Aspects of the disclosure relate generally to machine learning. More specifically, aspects of the disclosure may allow for using a machine learning system to analyze a computer architecture, determine components of the architecture, determine one or more potential failure points, and perform remedial actions.

Modern computer architectures, such as the architectures of server and networking nodes in a largescale network, can be extremely complicated and difficult to analyze. In many instances, systems designed to have redundancy still maintain a single or few points of failure, which can be difficult to detect. Further, even if points of failure are known, it is difficult to synthesize their impact to determine the probability of failure or remedial actions.

Aspects described herein may address these and other problems, and generally improve the ability to manage failures in a computer network. Further, aspects herein provide integrated optional processes regarding training a machine learning system and performing remediation on a failed system.

### BRIEF STATEMENT OF THE INVENTION

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects of the disclosure may allow for using a machine learning system to analyze a computer architecture, determine components of the architecture, determine one or more potential failure points, and perform remedial actions. This may have the advantage of providing automated systems for reducing the impact of failures in a computer architecture.

Aspects discussed herein may relate to methods and techniques for using a multi-step approach to automatically analyze the computer architecture of a system to determine the possible points of failure. A first stage may process, such as by using machine learning, one or more architecture diagrams (e.g., images or other such depictions of components) of the system architecture using hardware and/or software. The first stage may create a data graph that summarizes the network architecture and its relationships. A second stage may take the data graph and process it to determine likely points of failure and/or areas where redundancy may be needed. For example, the second stage may process the data graph, such as by using machine learning, to determine probabilities of failure at various points in the architecture, and determine the most likely cause of a particular failure. The system may then determine remedial steps to take in the case of failure. For example, the system may determine a subset of software components most likely to cause a particular type of failure, and may automatically restart those software components if the particular type of failure is detected.

More particularly, a system of one or more computers can be configured to perform particular operations or actions by virtue of having software, firmware, hardware, or a combination of them installed on the system that in operation causes or cause the system to perform the actions. The operations may include receiving one or more images depicting a computer architecture may include one or more components; determining, by a first machine learning model performing spatial analysis of the one or more images, a mapping of metadata to the one or more components, where the first machine learning model is trained to output the mapping based on historical component descriptions; constructing, based on the mapping, an ordered graph indicating one or more relationships between the one or more components, where the ordered graph may include the mapped metadata; determining, by a second machine learning model performing structural analysis on the ordered graph, one or more failure points associated with the one or more components; and presenting, using a display, a user interface depicting the one or more failure points. Other embodiments of this aspect include corresponding computer systems, apparatus, and computer programs recorded on one or more computer storage devices, each configured to perform the actions of the methods.

Implementations may include one or more of the following features. The one or more components may include hardware components or software components. The historical component descriptions may include domain-specific language associated with the computer architecture or labeled images of diagram components. The method may include training the second machine learning model based on historical data associated with real-world failures. The method may include de-noising the one or more images prior to the determining the mapping. The ordered graph may be formatted according to JavaScript object notation (json). The method may include determining, based on the one or more failure points, one or more remedial actions for the computer architecture; and performing, based on detecting a failure of a subset of the one or more components, the one or more remedial actions.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a computing device that may be used to implement one or more illustrative aspects discussed herein;

FIG. 2 illustrates an example deep neural network architecture;

FIG. 3 illustrates an example image interpreter, which may correspond to a first stage of the system;

FIG. 4 illustrates an example predictive system, which may correspond to a second stage of the system; and

FIG. 5 illustrates an example method for predicting likely points of failure in a system and/or taking remedial action based on known possible points of failure

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects of the disclosure may allow for using a machine learning system to analyze a computer architecture, determine components of the architecture, determine one or more potential failure points, and perform remedial actions. This may have the advantage of providing automated systems for reducing the impact of failures in a computer architecture. In some instances, there may be many layers to architectures for executing services or applications on a software platform. For example, a service may utilize many layers of data sources, servers, and networking components in order to facilitate execution of the service. If a request is made of the service (e.g., a request for data from a repository), the request may fail.

By analyzing the computer architecture, a system may be able to predictively determine the most likely points of failure. For example, a two-stage approach may be utilized. A first stage may process, such as by using machine learning, one or more architecture diagrams (e.g., images or other such depictions of components) of the system architecture using hardware and/or software. The first stage may create a data graph that summarizes the network architecture and its relationships. The data graph may be an ordered data graph (e.g., a data graph comprising metadata associating various components in an ordered manner). A second stage may take the data graph and process it to determine likely points of failure and/or areas where redundancy may be needed. For example, the second stage may process the data graph, such as by using machine learning, to determine probabilities of failure at various points in the architecture. The second stage may determine associations using a neural network, and may determine the most likely points of failure based on what associations have the highest failure rates and/or the highest impact upon failure based on the mapping.

The system may then determine remedial steps to take in the case of failure. For example, the system may determine a subset of software components most likely to cause a particular type of failure, and may automatically restart those software components if the particular type of failure is detected.

Aspects described herein improve the functioning of computers by implementing an automatic (e.g., computer-implemented) process whereby potential failures in other computing components can be identified. Broadly speaking, computers (particularly in large enterprise networks involving large quantities of interoperating servers, computers, network devices, and the like) are not capable of identifying potential points of failure, particularly where efforts have already been made to ensure redundancies are available. In turn, when failures occur, they can often times be unexpected and quite damaging. Those failures can result in data loss, hardware damage, service unavailability, significant financial losses, and the like. Aspects described herein help alleviate this risk by enabling computers to do what they could not do before: for instance, processing data (e.g., images depicting a network, text describing a network) to understand a network and predict potential failures in that network. Moreover, the volumes of data involved and the nuance of such processing prevent humans from performing similar steps. Indeed, even with a team of talented computer engineers, many of the steps provided herein would be impossible given the speed with which systems change, the volume of data available about those systems at any given time, and the overall difficulty of detecting potential failures.

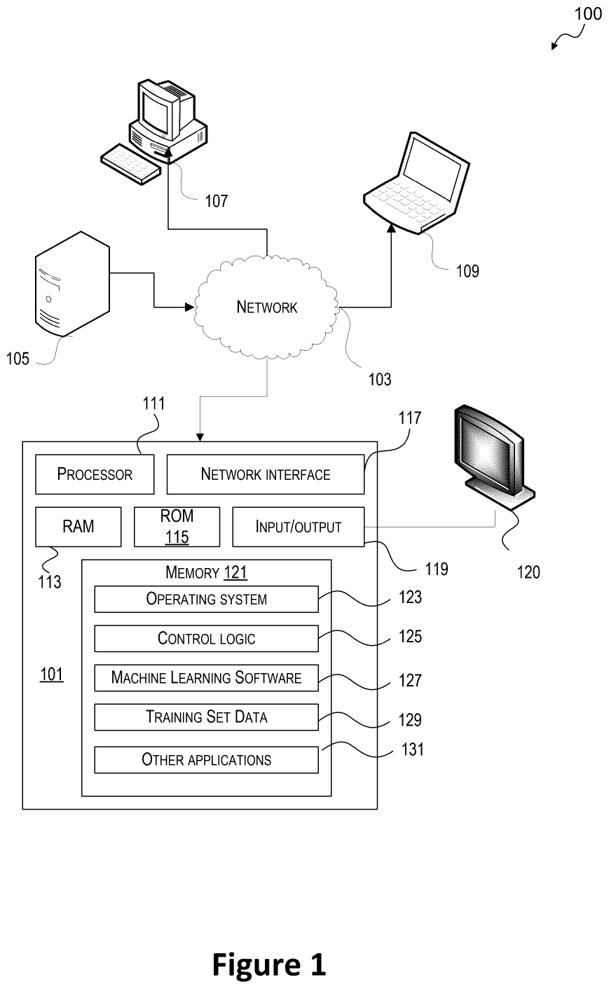

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 129. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, devices 101, 105, 107, 109, and others may operate in concert to provide parallel computing features in support of the operation of control logic 125 and/or software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Having discussed several examples of computing devices which may be used to implement some aspects as discussed further below, discussion will now turn to systems and methods for architecture detection and predictive self-healing.

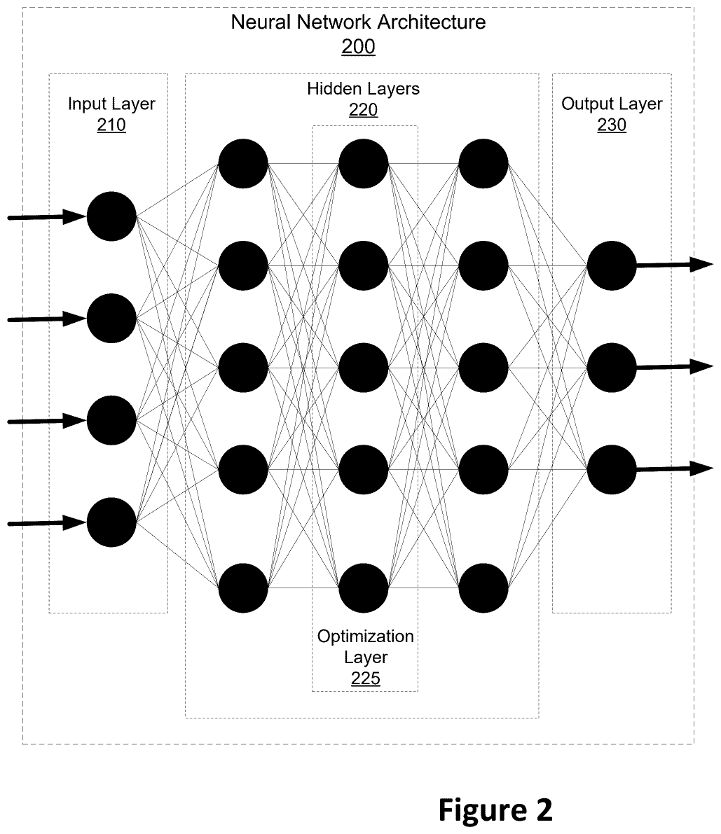

FIG. 2 illustrates an example deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

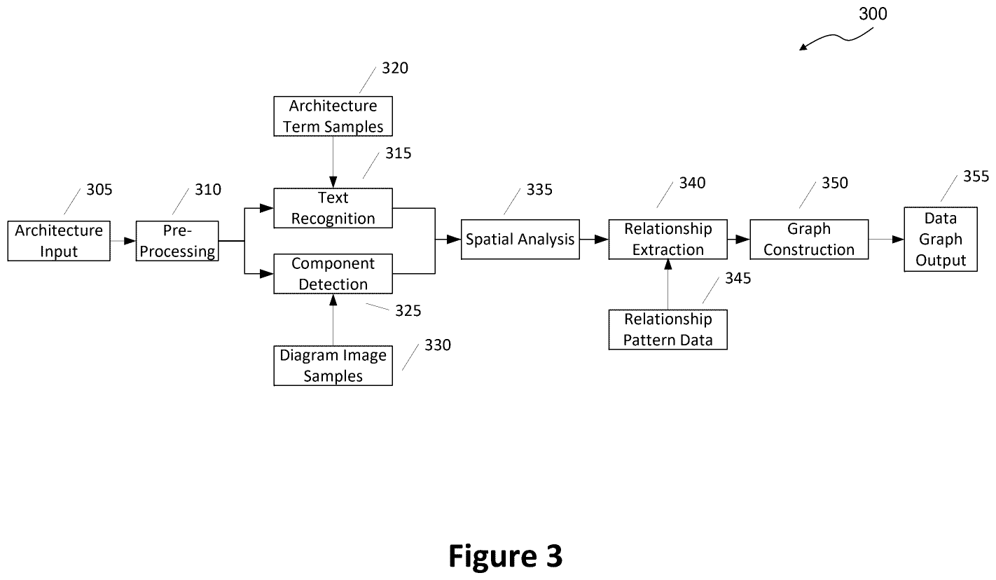

FIG. 3 illustrates an example image interpreter 300, which may correspond to a first stage of the system. The image interpreter 300 may be configured to analyze a received architecture input 305, which may be a diagram image of a computer architecture. The image interpreter may then determine a data graph output 355, which may comprise a data graph comprising an ordered list of components along with associated metadata for those components. For example, the diagram image may comprise one or more images of various aspects of a computer architecture (e.g., services, servers, routers, data sources, network links, software links, APIs, etc.). In some instances, the architecture input may be other data, such as a Visio file or other such data file depicting the architecture.

The image interpreter 300 may have a pre-processing system 310 that may pre-process the architecture input 305 to make it more suitable for processing. For example, the architecture input 305 may undergo processes such as noise reduction, binarization, or normalization in order to produce a more-optimized input for computer analysis.

The image interpreter 300 may have one or more systems for processing the architecture input 305 in order to determine one or more components associated with the architecture. The image interpreter 300 may have a text recognition system 315 for determining text in the architecture input 305. The text recognition system 315 may be trained on known data, such as architecture term samples 320. For example, the text recognition system 315 may be trained based on a thesaurus of known architecture terms, and/or by feeding in textual material regarding known systems. Such textual information may comprise domain-specific language associated with the computer architecture. These terms may be used to identify textual descriptions, decipher acronyms, and provide consistent and accurate metadata for components consistent with the textual descriptions. In some instances, the term samples may be processed using a neural network, optical character recognition, and/or natural language processing in order to automatically determine the appropriate metadata for association with textual descriptions in the architecture input 305.

The image interpreter 300 may have a component detection system 325, which may detect symbolic or image representations of components in the architecture input 305. For example, there may be known images or symbols for servers, services, routers, connections between devices, etc. For example, optical connections may be depicted using one type of line of a certain color and format, while API-based software connections may be depicted using a different type of line using a different color and format. The component detection system 325 may be trained (e.g., as a neural network) using diagram image samples 330. For example, a neural network (e.g., a convolutional neural network) may be trained by inputting labeled representations of various components in order to train the component detection system 325 what the depictions in the architecture input 305 represent.

The image interpreter 300 may comprise a spatial analysis system 335. In some instances, the component detection system 325 and the text recognition system 315 may work in conjunction with one another to detect components. For example, a neural network may take the result of both systems (e.g., using spatial analysis and/or heuristics) to determine various components based on the depiction of the component and a label associated with the component. This may have the advantage of improving accuracy, and may use one or more neural networks.

The image interpreter 300 may comprise a relationship extraction system 340. Using the spatial analysis, the relationship extraction system 340 may determine the relationships between various components and associated metadata. The relationship extraction system 340 may determine (e.g., using a Hough transform and/or machine learning model) the spatial orientation of various aspects of the architecture input 305. For example, the relationship extraction system 340 may determine what depicted components are connected using what depicted connectors, associated with which labels. For example, the relationship extraction system 340 may determine that a particular AWS service is connected to a particular server using a particular API call. The relationship extraction system 340 may be trained using known patterns, relationships, or heuristic analysis. For example, the relationship extraction system 340 may be trained to recognize that a software service will have one or more connections using depictions of an API call. In another example, the relationship extraction system 340 may be programmed specifically to identify points of interconnection in order to list associated connections.

The image interpreter 300 may be configured to identify patterns and/or redundancies in components. Some systems may comprise multiple instances of the same or similar devices (e.g., a work laptop assigned to each employee of a large organization, network switches on every floor of a building). In turn, as part of determining relationships between components, the image interpreter 300 might recognize instances where components are the same or similar, even where those components might be located at different parts of a system. Such relationships might have implications for the vulnerability of the system: for example, two nearly-identical devices might share the same remote code execution vulnerabilities if they operate the same software stack.

The image interpreter 300 may be configured to identify different types of relationships between components. Some components may be physically connected (e.g., two different servers communicating via a wired or wireless network) whereas some components may be logically connected (e.g., collocated on the same server hardware and communicating via an API or similar interface). These different types of relationships might imply different forms of vulnerabilities: for instance, the failure of a software routine on a server might have larger implications for the security of the server as a whole (e.g., in the case of a buffer overflow or the like), whereas the failure of a discrete piece of hardware could potentially have minimal impact on a system (e.g., as might be the case where an employee drops and breaks their work laptop).

The image interpreter 300 may comprise a graph construction system 350. Using the determined relationships, and metadata for the various components, the graph construction system 350 may create an ordered graph output 355 indicating the various components and their connections with one another. For example, the graph construction system 350 may generate an ordered graph listing each component, metadata about each component, and all connections that component has with other components. For example, the ordered graph may list a particular service, metadata about that service, and a list of all the hardware and/or software components that the service is connected to. Metadata may comprise descriptions of any aspect of the system. For example, it may comprise a name of the component, a manufacturer, a build date, a size, a type of component, what the component does, where it is located, processing power of the component, or any other such description of a component as would be useful to the system. The ordered graph may be in any suitable file format, such as a data file formatted according to JavaScript Object Notation (JSON).

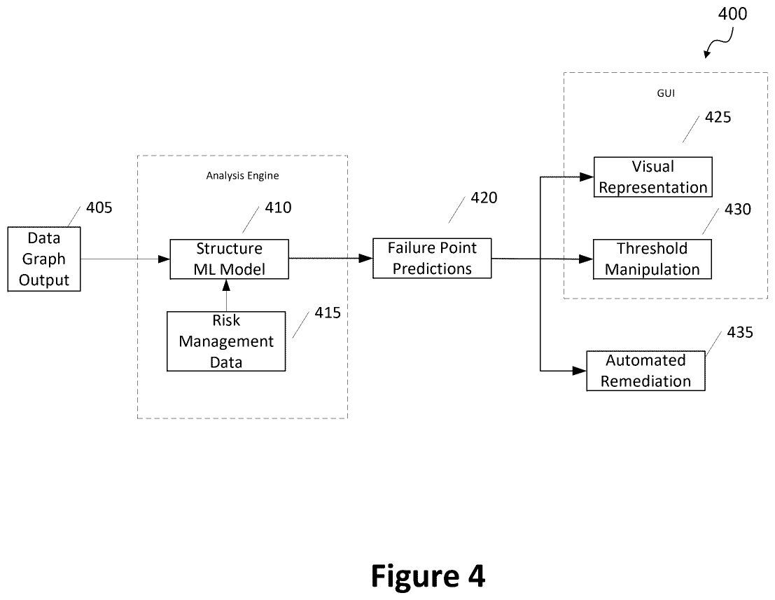

FIG. 4 illustrates an example predictive system 400, which may correspond to a second stage of the system. The predictive system 400 may be configured to take an input, such as a data graph 405 (which may be the same as the ordered graph output 355), and process the data graph to determine the most likely points of failure in the system and/or points of remediation in case of failure.

The predictive system 400 may comprise a structure machine learning model 410, which may be trained using risk management data 415. The structure machine learning model 410 may comprise any form of machine learning model, and is referred to as a structure machine learning model herein for the purposes of nomenclature and based on the idea that the machine learning model may analyze computer architecture structure. The structure machine learning model 410 may be a machine learning model (e.g., a Bayesian-network machine learning model) configured to determine the structure of a computer architecture using an input such as the data graph 405. For example, the structure machine learning model 410 may be configured to read the data graph 405, analyze all the components with its corresponding metadata and noted connections, and gain an understanding of the totality of the network. To gain more useful output, it may be advantageous to train the structure ML model using risk management data 415. The risk management data 415 may comprise known risk data for the architecture being analyzed, or of other known architectures. For example, the risk management data 415 may comprise data indicating known instances of failure of the architecture, as well as the results and/or what components were responsible for the failures. In another example, the risk management data 415 may comprise risk data for other, similar architectures, which may inform the structure machine learning model 410 as to what failures may be likely in the architecture depicted in the data graph 405.

Using the risk management data 415, and the data graph 405, the structure machine learning model 410 may generate failure point predictions 420. The failure point predictions 420 may comprise a listing of predicted failure points of the architecture based on the analysis of the synthesized architecture and risk data that are processed by the structure machine learning model 410. The failure point predictions 420 may indicate the likelihood of failures and/or the impact of those failures. For example, the failure point predictions 420 may indicate that a particular service is 20% likely to fail in a 6-month span, and has a 50% likelihood of causing a certain type of request to fail, which represents a 35% chance of being the root cause of failure if that certain type of request were to fail (relative to other possible points of failure determined by the structure machine learning model 410).

The predictive system 400 may comprise a graphical user interface (GUI) for indicating the failure point predictions. The GUI may comprise visual representations 425 of the various components in the system and/or their predicted failure points, and/or threshold manipulations 430 for altering the output of the GUI. For example, the visual representation 425 may depict a list of possible failures in the system, ranked in order of likelihood, and may provide an interface wherein a user may click on each possible point of failure to see its cause and/or effects. In another example, the visual representation 425 may depict a computer architecture of the whole system, as created using the methods and systems described herein, which a user can scroll and view. This may be advantageous because the architecture input 305 may comprise a number of images and/or diagrams for the architecture, and the GUI could thus depict a holistic view of the architecture which may not exist in any single source document. The threshold manipulation 430 may permit a user to modify the view. For example, a user could adjust the threshold manipulation 430 to determine what likelihood or severity of error the user wishes to display. For example, the user may use the threshold manipulation 430 to depict only failures that cause a request to fail and are 5% likely to occur in a 3-month span. In another example, the user may use the threshold manipulation 430 to depict failures that are likely to cause a 50 ms delay in response time and are at least 20% likely to occur in a 6-month span.

In some instances, the predictive system 400 may enable a user to interact with the GUI in order to view the effects of various failures. This may allow the user to interactively select individual components, select a cause of failure (e.g., a power failure, data failure, software lock, etc.), and view the repercussions of the failures. For example, a user could select a particular server, toggle the server to have a power failure, and then see the cascading effects of the power failure in the architecture including certain types of requests having a very long latency or being non-responsive. This may have the advantage of allowing a user to intelligently examine a system and determine where additional redundancies (e.g., backup servers, services, or data stores) would be beneficial.

The predictive system 400 may include an automated remediation system 435. The automated remediation system 435 may be automated to allow the system to automatically perform remediation for a failure based on the most likely cause of failure and known solutions. In some instances, the failure point predictions 420 may identify components that are the most likely to fail, and errors that are the most likely to result in those failures. This may be determined by the structure machine learning model 410 by analyzing the data graph output 405 and correlating it with known risk management data 415 for the associated architecture. Since the possible causes of failure are known, when a particular failure occurs (e.g., a data request is non-responsive or has a delay outside of bounds), the predictive system 400 may trigger a remedial action for the failure (e.g., restarting a particular service on a particular server). The remedial action may be based on remedial actions that were taken after failures noted in the risk management data 415, or they could be determined by the structure machine learning model based on its analysis of the system.

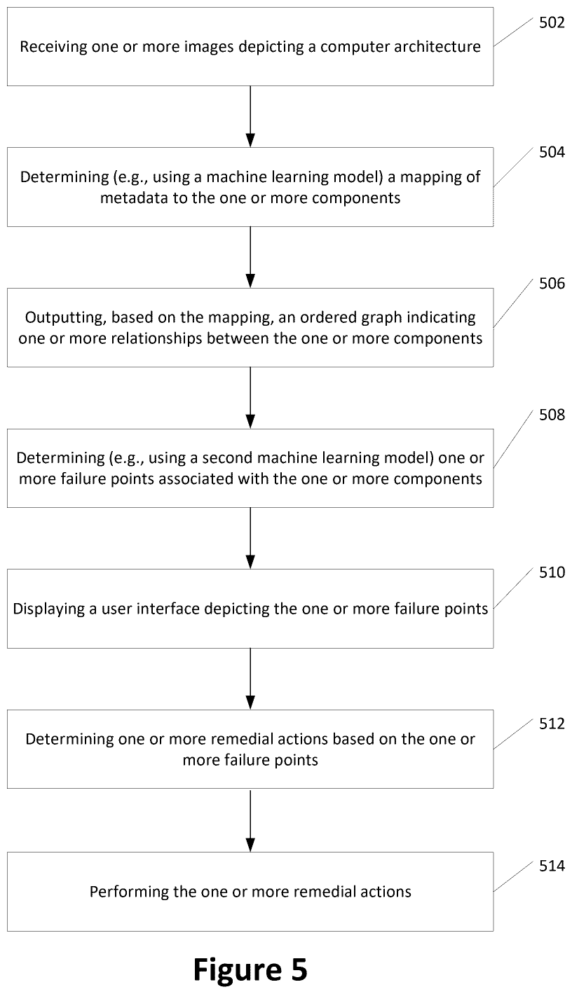

In accordance with the above detailed description, aspects described herein may provide a computer-implemented method for predicting likely points of failure in a system and/or taking remedial action based on known possible points of failure. Exemplary steps of such a method 500 are shown in FIG. 5. The system implementing the steps may be one or more computing devices, such as one or more computing devices 100 as may be depicted in FIG. 1. The system may be configured consistent with an image interpreter 300 and/or a predictive system 400, as may be depicted in FIGS. 3 and 4. The descriptions of those systems and their functionality may be consistent with the discussion below regarding method 500. The system may comprise one or more machine learning models, such as those discussed in FIGS. 2, 3, and 4.

At step 502, the system may receive one or more images depicting a computer architecture. The one or more images may be consistent with the architecture input 305 as may be described above regarding FIG. 3. In some instances, the one or more images may comprise additional or substitute information, such as architectural diagrams in a suitable file format. For example, the architecture input 305 may comprise a Visio file, or other such data file which may or may not comprise actual images. The one or more images may depict one or more components, which may be one or more components of a computer architecture as described herein. The one or more images may be pre-processed to obtain versions of the one or more images more suitable for processing, as may be described above.

At step 504, the system may determine a mapping of metadata to the one or more components. For example, the system may apply text recognition system 315 and/or component detection system 325 in order to determine metadata corresponding to the one or more components. For example, the metadata may comprise a name of the component, a manufacturer, a build date, a size, a type of component, what the component does, where it is located, processing power of the component, or any other such description of a component as would be useful to the system. This process may entail machine learning. For instance, a machine learning model may be trained to identify components in images and/or text based on training data comprising a plurality of different images of illustrative computer systems. Such images may have been tagged based on identifies and/or locations and/or relationships of components in those illustrative computer systems; however, the machine learning model might alternatively be trained in an unsupervised manner where such tagging is not provided. The trained machine learning model may then be provided, as input via one or more input nodes, the one or more images from step 502 and might output, in response to that input and via one or more output nodes, all or portions of the mapping of the metadata.

The determining of metadata may further be based on spatial analysis of the one or more components. This may be based on the spatial analysis system 335 and/or relationship extraction system 340, which may comprise one or more machine learning models. The analysis may be based on historical component descriptions, which may comprise diagram image samples 330, architecture term samples 320, relationship pattern data 345, or other such historical term descriptions as may be useful to assist the system in analyzing the architecture input 305. For example, the system may receive as input a technical thesaurus, term definitions from proprietary documents, historical documents relating to technical components, pre-labeled component mappings, or previously analyzed architectures with metadata associated with known components.

At step 506, the system may output an ordered graph (e.g., data graph output 355), which may indicate one or more relationships between the one or more components. The system may construct the ordered graph based on the mapping determined in step 504. For example, the ordered graph may comprise a data file consisting of a listing of all the components identified by the system, the connections between each of those components and other components of the one or more components, and/or metadata describing the components and their respective connections.

At step 508, the system may determine one or more failure points associated with the one or more components. This determination may be performed by an additional machine learning model (e.g., an additional model to the one or more machine learning models utilized in steps 502 through 506). For the example, an analysis engine such as may be described in FIG. 4 may utilize a structure machine learning model 410 to analyze the outputted ordered graph (e.g., the data graph output 405, which may be the data graph output 355), in order to determine failure point predictions 420. The analysis may be based on historical data, such as risk management data 415.

At step 510, the system may display a user interface depicting the one or more failure points. For example, the system may display a user interface listing one or more failing points as may be identified in the failure point predictions 420. For example, the system may display a listing of possible failure points where the user may click on each selection in order to see an expanded description of the failure points along with metadata associated with components related to the predicted failure points. The display may comprise information related to the failure point predictions 420, such as the probability of the failure occurring with a particular time period, the impact of the failure (e.g., what services or queries may be impacted by the failure), the severity of the failure (e.g., the length of delays in responses, how may services are impacted, etc.), the time to cure the deficiencies, possible remedial actions (e.g., which services could be reset to solve the problem, redundancies that could be added to avoid the failure, etc.), or other such information as may be appropriate.

At step 512, the system may determine one or more remedial actions based on the one or more failure points. For example, the system may determine that resetting a given service or set of services may likely result in correcting the failure points.

At step 514, the system may perform the one or more remedial actions (e.g., using the automated remediation system 435). For example, the system may determine that a failure point has occurred that corresponds to a failure point prediction 420. Using one or more rules, the system may automatically employ a remedial action in order to correct the failure. For example, the system may reset the given service or set of services. In some instances, the one or more rules and/or the remedial actions may be automatically determined by the system. For example, the system may determine what remedial actions are most likely to resolve a given failure point, based on the failure point predictions 420 and other such determinations by the system, and may automatically deploy such remedial actions if the failure is detected. In other instances, the one or more rules and/or the remedial actions may be selected by a user. For example, a user may use a GUI, as may be described in FIG. 4, to select various remedial actions that may be taken for given failure points. In other instances, the system may determine remedial actions through a combination of user selection and automated selection. For example, the user may enable remedial actions for a certain classification of failures (e.g., a total failure of certain services, delays in response beyond a threshold, etc.), for one or more types of remedial actions (e.g., restarting certain non-essential services, but not actions that interrupt other essential services such as mission-critical communication services).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving one or more images depicting a computer architecture comprising one or more components;
determining, by a first machine learning model performing spatial analysis of the one or more images, a mapping of metadata to the one or more components, wherein the first machine learning model is trained to output the mapping based on historical component descriptions;
constructing, based on the mapping, an ordered graph indicating one or more relationships between the one or more components, wherein the ordered graph comprises the mapped metadata;
determining, by a second machine learning model performing structural analysis on the ordered graph, one or more failure points associated with the one or more components; and
presenting, using a display, a user interface depicting the one or more failure points.

2. The method of claim 1, wherein the one or more components comprise one or more of:
hardware components, or
software components.

3. The method of claim 1, further comprising training the first machine learning model based on the historical component descriptions, wherein the historical component descriptions comprise:
domain-specific language associated with the computer architecture; and
labeled images of diagram components.

4. The method of claim 1, further comprising training the second machine learning model based on historical data associated with real-world failures.

5. The method of claim 1, further comprising de-noising the one or more images prior to the determining the mapping.

6. The method of claim 1, wherein the ordered graph is formatted according to JavaScript Object Notation (JSON).

7. The method of claim 1, further comprising:
determining, based on the one or more failure points, one or more remedial actions for the computer architecture; and
performing, based on detecting a failure of a subset of the one or more components, the one or more remedial actions.

8. A system comprising:
a computing device;
a first machine learning model; and
a second machine learning model;
wherein the computing device is configured to:
receive one or more images depicting a computer architecture comprising one or more components;
receive, from the first machine learning model, a mapping of metadata to the one or more components;
construct, based on the mapping, an ordered graph indicating one or more relationships between the one or more components, wherein the ordered graph comprises the metadata;
receive, from the second machine learning model, one or more failure points associated with the computer architecture; and
present, using a display, a user interface depicting the one or more failure points;
wherein the first machine learning model is configured to determine the mapping by performing spatial analysis of the one or more images; and
wherein the second machine learning model is configured to determine the one or more failure points by performing structural analysis on the ordered graph.

9. The system of claim 8, wherein the one or more components comprise one or more of:
hardware components, or
software components.

10. The system of claim 8, wherein the first machine learning model is trained based on:
domain-specific language associated with the computer architecture; and
labeled images of diagram components.

11. The system of claim 8, wherein the second machine learning model is trained based on historical data associated with real-world failures.

12. The system of claim 8, wherein the computing device is further configured to:
de-noise the one or more images; and
prior to receiving the mapping, send the de-noised one or more images to the first machine learning model, wherein the first machine learning model is configured to perform the determining the mapping by performing the spatial analysis of the de-noised one or more images.

13. The system of claim 8, wherein the ordered graph is formatted according to JavaScript Object Notation (JSON).

14. The system of claim 8, wherein the computing device is further configured to:
determine, based on the one or more failure points, one or more remedial actions for the computer architecture; and
perform, based on detecting a failure of a subset of the one or more components, the one or more remedial actions.

15. A non-transitory computer-readable medium storing computer instructions that, when executed by one or more processors, cause performance of actions comprising:
receiving one or more images depicting a computer architecture comprising one or more components;
determining, by a first machine learning model performing spatial analysis of the one or more images, a mapping of metadata to the one or more components;
constructing, based on the mapping, an ordered graph indicating one or more relationships between the one or more components, wherein the ordered graph comprises the metadata;
determining, by a second machine learning model performing structural analysis on the ordered graph, one or more failure points associated with the one or more components;
determining, based on the one or more failure points, one or more remedial actions for the computer architecture; and
performing, based on detecting a failure of a subset of the one or more components, the one or more remedial actions.

16. The non-transitory computer-readable medium storing computer instructions of claim 15, wherein the one or more components comprise one or more of:
hardware components, or
software components.

17. The non-transitory computer-readable medium storing computer instructions of claim 15, when executed by the one or more processors, further cause performance of actions comprising:
training the first machine learning model based on one or more of:
domain-specific language associated with the computer architecture, or labeled images of diagram components; and
training the second machine learning model based on historical data associated with real-world failures.

18. The non-transitory computer-readable medium storing computer instructions of claim 15, when executed by the one or more processors, further cause performance of actions comprising de-noising the one or more images prior to the determining the mapping.

19. The non-transitory computer-readable medium storing computer instructions of claim 15, wherein the ordered graph is formatted according to JavaScript Object Notation (JSON).

20. The non-transitory computer-readable medium storing computer instructions of claim 15, when executed by the one or more processors, further cause performance of actions comprising:
determining, based on the one or more failure points, one or more remedial actions for the computer architecture; and
performing, based on detecting a failure of a subset of the one or more components, the one or more remedial actions.
